(19) United States
(12) Patent Application Publication
(10) Pub. No.: US 2008/0034058 A1
(43) Pub. Date: Feb. 7, 2008

(54) Method and system for populating resources using web feeds

(75) Inventors: Walter Korman, Seattle, WA (US); Cameron Ferroni, Seattle, WA (US); Lara Ferroni, Seattle, WA (US)

Correspondence Address: PERKINS COIE LLP;PATENT-SEA, P.O. BOX 1247, SEATTLE, WA, 98111-1247, US

(73) Assignee: Marchex, Inc.

(21) Appl. No.: 11/498,217

(22) Filed: Aug. 1, 2006

(51) Int. Cl. G06F 15/16

(52) U.S. Cl. 709/217

(57) ABSTRACT

A software and/or hardware facility that identifies and characterizes web feeds and web feed content for purposes of populating a resource with targeted content. The facility identifies web feeds and characterizes the web feeds and/or content in the web feeds using attributes from an attribute taxonomy. The characterization may be based on metadata associated with the web feed and/or on content in the web feed. Once the web feeds and/or content of the web feeds have been characterized, the web feeds and content may be appropriately selected for inclusion in a resource. The resource may be targeted to recipients based on identified characteristics of the resource or recipients.

### TECHNICAL FIELD

The described technology relates to the field of identifying content for inclusion in resources.

### BACKGROUND

It has become increasingly popular for websites and other content sources, including news websites, weblogs, and other services, to publish web feeds. Web feeds are typically XML-based documents that contain content items, including articles, weblog posts, and content summaries with hyperlinks to complete versions of the content items. Web feeds are increasingly being used to deliver any type of structured information that recipients (either users or services) desire receiving on a periodic basis. By publishing content with a web feed, the content producer provides a timely distribution of information to those recipients that receive the feed.

While many users and services have found web feeds to be an invaluable mechanism to receive content from content providers, searching and identifying valuable web feeds can be a time-consuming process. A recipient primarily has two techniques to identify a web feed. The first technique is to visit a content provider's site and look for an indication from the provider than a web feed is provided for all or a portion of the content on that site. The indication typically takes the form of an icon or other graphical element that indicates the existence of the feed. The second technique to identify a web feed is to visit an aggregator site, such as feedster.com, syndic8.com, or feedburner.com. The aggregator sites periodically compile a list of available web feeds that are published from the aggregator's site or from other sites, and make the list searchable via search queries. Whether identified by visiting a content provider site or by visiting an aggregator site, locating relevant web feeds that are useful to recipients may be a time-consuming process. It would therefore be beneficial to identify web feeds and the content of web feeds in a more efficient manner so that user or services can more quickly identify web feeds or web feed content of interest.

### BRIEF DESCRIPTION OF THE DRAWINGS

FIG. 1 is a block diagram that illustrates components of a facility for identifying and categorizing web feeds and web feed content.

FIG. 2 is a flow diagram that illustrates the identification and categorization of a web feed.

FIG. 3 is a block diagram that illustrates records in a web feed database.

FIG. 4 is a flow diagram that illustrates the identification and characterization of web feed content.

FIG. 5 is a block diagram that illustrates records in a content database.

FIG. 6 is a representative screenshot depicting web feeds and web feed content that have been selected and used to populate a resource.

FIG. 7 is a flow diagram illustrating the selection of web feeds and web feed content for purposes of populating a resource.

### DETAILED DESCRIPTION

A software and/or hardware facility is described that identifies and characterizes web feeds and web feed content for purposes of populating a resource with targeted content. The facility identifies web feeds and characterizes the web feeds and/or content in the web feeds using attributes from an attribute taxonomy. The characterization may be based on metadata associated with the web feed and/or on content in the web feed. Once the web feeds and/or content of the web feeds have been characterized, the web feeds and content may be appropriately selected for delivery to users and/or services in a targeted manner. Specifically, when a user or a service requests a specific resource, web feeds and content from web feeds may be selected for inclusion in the resource. The resource may be a web page that contains content or search results, a document containing content for a user, an XML document responsive to a service request, a metafeed (as defined below), or any other resource that would benefit from targeted content derived from web feeds. The web feeds and content that are selected may be based on characteristics of the requesting user or service (such as the identity or location of the user or service), characteristics of the resource (such as the Uniform Resource Indicator (URI) or general subject matter of the resource), or any other characteristic that is known by the facility that may be used to better target the populated content to the requesting user or service.

In some embodiments, the facility relies upon an attribute taxonomy that is partitioned in a variety of ways. One set of attributes may be a geographical classification system that may be used to characterize web feeds or web feed content based upon a geography (e.g., city, state, region, latitude and longitude) associated with that feed or content. A second set of attributes may be a topical classification system, which may be used to characterize web feeds or content based upon a topical classification (e.g., news, sports, product reviews) associated with that feed or content. Additional sets of attributes may be defined by the facility depending on the identity of the web feed and content, as well as the type of resource that is to be populated. Appropriate attributes are selected by the facility and associated with web feeds and feed content in order to characterize the web feeds and feed content. By utilizing an attribute taxonomy that has been partitioned in a variety of ways, the facility can provide highly targeted web feed and web feed content to requesting users or services.

In some embodiments, the facility utilizes the characterized web feeds and/or web feed content to populate web pages identified by a uniform resource indicator (URI). Uniform resource indicators, such as “www.seattlekayaks.com,” are used to identify the location of specific content on the web or other network, and will often contain information within the URI that suggests the content that should be associated with that resource. For example, the URI www.seattlekayaks.com suggests both a geography (Seattle) and a topic (kayaks) that might be relevant to the URI. By analyzing the URI, the facility is able to select appropriate web feeds and web feed content that may be preferably associated with a resource accessed via the URI. The facility may use the web feed and web feed content to populate one or more resources that are accessible via the URI or any extensions of the URI (e.g., sales.seattlekayaks.com or seattlekayaks.com/trips). The facility thereby allows resources to be automatically created that are relevant and useful to users requesting the resource associated with the URI.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

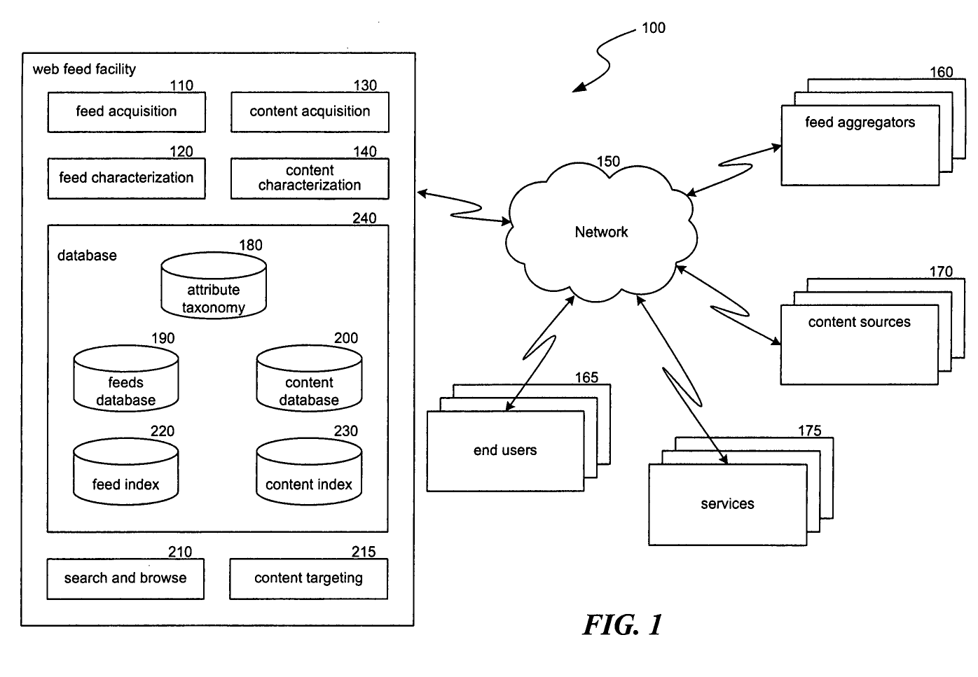

FIG. 1 is a block diagram illustrating the components of a web feed facility 100. The web feed facility is capable of accessing web feeds provided by feed aggregators 160 or content sources 170 via a network connection, such as the Internet 150. The web feed facility 100 is capable of automatically characterizing the accessed web feeds and/or web feed content, such that the web feeds and web feed content may subsequently be used to populate a resource with targeted content. The web feed facility is comprised of a number of components to acquire and characterize the web feeds and web feed content, including a feed acquisition component 110, a feed characterization component 120, a content acquisition component 130, and a content characterization component 140. The feed acquisition component identifies web feeds that are typically accessed via a network such as the Internet 150. The web feeds may be identified by directly accessing content sources 170, such as web sites run by news organizations, sports bureaus, weather sites, blogs, or other content providers. Alternatively, the feeds may be identified by accessing one or more feed aggregators 160. Feed aggregators 160 are typically web sites that have crawled the web to identify available feeds, or that offer syndication or other services to web feed providers so that web feed providers seek to have their web feed listed on the aggregation site. Aggregator sites typically provide a feed index to allow users or services utilizing the aggregator site to find web feeds of interest. Moreover, aggregator sites usually offer the ability to subscribe to a web feed, and may automatically check for and retrieve new web feed content at user-, system- or publisher-determined intervals. The feed acquisition component 110 may, on a continuous or periodic basis, search for and identify new web feeds that have not been previously identified by the web feed facility. The facility operator may also manually identify web feeds that are deemed to be of interest to the feed acquisition component. Users of the facility may also be provided an opportunity to request, identify, or submit new feeds to the facility operator. The facility operator may elect to have all feeds identified in any fashion characterized, or only characterize those feeds that have a certain content type or meet a certain quality, reputation, distribution level, etc.

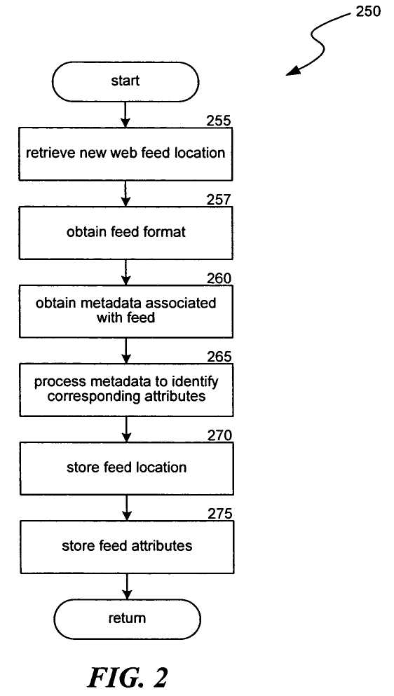

Once a web feed has been identified by the feed acquisition component 110, it is analyzed by the feed characterization component 120 and characterized using one or more attributes contained in an attribute taxonomy 180. FIG. 2 is a flow diagram that illustrates the web feed characterization process 250 that is implemented by the feed characterization component 120. At a block 255, a new web feed location is received from the feed acquisition component 110. Those skilled in the art will appreciate that web feeds are provided in a variety of different formats (e.g., RSS, Atom, RDF, tab-delimited), are published at various rates (e.g., sporadically, regularly), differ greatly in the amount of content that is published, and typically specify a set of rules under which a web feed or portion of a web feed may be reused or redistributed. At a block 257, the feed characterization component 120 therefore initially identifies the format and any rules associated with the identified web feed in order to appropriately receive and process the web feed.

At a block 260, the feed characterization component 120 obtains any metadata associated with the web feed that describes the contents of the web feed. Those skilled in the art will appreciate that the metadata associated with the feed can come from a variety of different sources. For example, certain information about the feed may be obtained from the content provider website, the aggregator website or from other sites that characterize the feed. Additionally, web feeds typically contain characterizing data in the feed itself, such as a title, a category, a copyright notice, or a short description of the web feed contents. Finally, the feed characterization component may monitor one or more pieces of content that are provided over the feed in order to identify representative pieces of content that are typically contained in the web feed. All of these sources of metadata may be used by the facility to characterize the general contents of the web feed.

At a block 265, the facility processes the metadata in order to characterize the web feed. Preferably, the feed characterization component 120 analyzes the metadata and associates significant terms or concepts in the metadata with one or more of the attributes from the attribute taxonomy 180. As was previously mentioned, attribute taxonomy 180 contains an organized structure of attributes. In some embodiments, the attribute taxonomy includes various sets of related attributes. One set of attributes may be a geographical classification system that includes geographic terms (e.g., city, state, region, latitude and longitude) that may be associated with a web feed or content. A second set of attributes may be a topical classification system that includes various topic descriptions (e.g., news, sports, product reviews) that may be associated with a web feed or content. A third set of attributes may be a language classification system that includes languages (e.g. English, Spanish, French). A fourth set of attributes may be a format of a web feed or content (e.g., text, image, audio, video). Still other sets of attributes may be defined by the facility operator, depending on the intended use of the facility. The facility may also provide a tool to allow an operator to create, modify and delete attributes and attribute relationships within the attribute taxonomy 180. Analyzing the metadata may encompass identifying significant terms in the metadata, such as terms that occur frequently or that are associated with named locations. The significant terms identified in the metadata are matched against those attributes that are contained in the attribute taxonomy 180. Matches or near matches may indicate that that identified attribute has some association with the corresponding web feed from which the metadata was obtained. Such attributes may therefore be matched with the web feed, and may be derived from one or more of the various attribute sets in the attribute taxonomy. Alternatively, or in addition to the automatic assignment of attributes to a web feed, a manual assignment of attributes to a web feed may be undertaken by an operator of the facility or by users of the facility. For example, the facility may automatically assign attributes to a web feed and an operator may confirm that the attributes have been correctly assigned before the web feed is further utilized by the facility. As another example, the facility may automatically assign attributes to a web feed and use the web feed without prior review. As part of the use of the web feed, however, the facility may provide a feedback mechanism to an end user to allow the end user to indicate to the facility or facility operator that the web feed had been incorrectly characterized. Such a feedback mechanism may range from a button allowing the user to indicate that the web feed appears to be incorrectly characterized, to a menu or form that allows the user to assign attributes to the web feed. By identifying a group of attributes that characterize a web feed from a normalized set of attribute terms, groupings of similar web feeds may be more readily identified. The assignment of attributes therefore allows the facility to accurately select web feeds and web feed content for inclusion in a targeted resource.

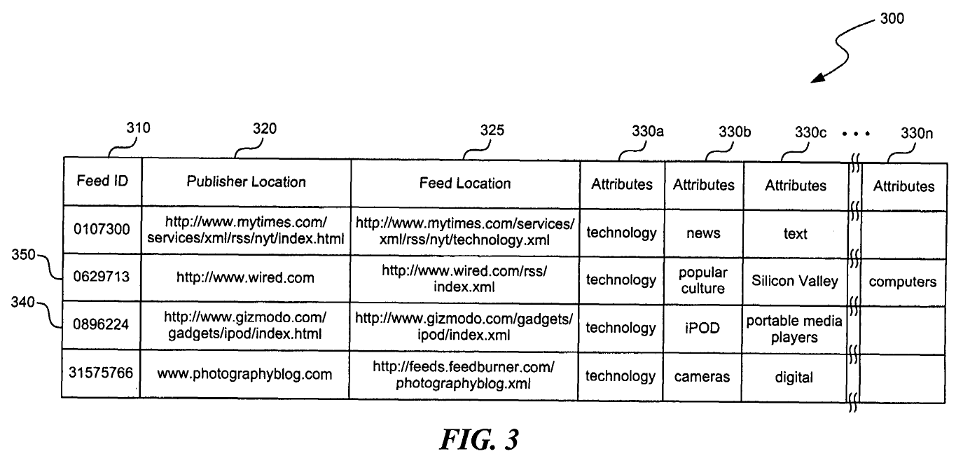

Once the feed characterization component 120 identifies one or more attributes that are associated with a web feed, the location of the web feed and the associated attributes are stored by the facility in a feed database 190. At a block 270, the feed location is stored in the feed database. The feed location is a URI or other pointer to a location where the feed may be retrieved. At a block 275, the feed characterization component stores the attributes that were identified by the automatic processing of metadata and/or by the manual characterization by the facility operator. FIG. 3 is a block diagram depicting how the web feed and the feed characterization may be stored.

FIG. 3, is a block diagram of a representative table 300 that stores web feed records in the feed database 190. Each record in the table corresponds to a single web feed, and includes a unique feed identifier, a web feed location, and attributes that characterize the web feed. Specifically, the table includes a feed ID field 310, a publisher location field 320, a feed location field 325, and a number of attribute fields 330a, 330b, . . . 330n. The feed ID field 310 is a unique identifier that is assigned by the facility to each feed. For example, in a representative record 340 the facility has assigned the feed an identifier number of “0896224.” The feed ID uniquely identifies the web feed and allows the facility to easily reference a particular feed. The publisher location field 320 contains a URI or other pointer to a location where a subscription to the feed may be requested from a publisher. In representative record 340, the publisher location is “http://www.gizmodo.com/gadgets/ipod/index.html,” which corresponds to a web page provided by the gizmodo.com website that is directed to IPod technology released by Apple Computer and by third parties. The feed location field 325 contains a URI or other pointer to the actual feed. In representative record 340, the feed location is http://www.gizmodo.com/gadgets/ipod/index.xml. In some cases, the feed location may be different from the publisher since the web feed is syndicated through other feed service web sites such as aggregator sites. One or more attribute fields 330a, 330b, . . . 330n are associated with each data record. The attribute fields each contain an attribute that the feed characterization component 120 has determined to characterize a particular web feed using the techniques described herein. For example, in record 340 the attributes that the facility determined to characterize the feed include the terms “technology,” “IPod,” and “portable media players.” Although three attributes are provided in this example, the number of attributes may be smaller or greater depending on the content scope of the web feed.

While the attributes have been represented in textual form in table 300 for benefit of this description, it will be appreciated that an actual implementation of the table may represent the attributes by unique codes, by a search index, or in other form. Moreover, while the attributes in record 340 are all drawn from the same set of topic attributes, other records may have attributes drawn from more than one set of attributes. For example, a representative record 350 includes both topic attributes (e.g., “technology,” “computers”) and geographic attributes (“Silicon Valley”). Other records may include format attributes (e.g., “video”) and other attributes from the attribute sets discussed above. On a periodic basis, the attributes in the table may be updated to reflect changes to the web feed, such as changes to the web feed content, feed publisher, or feed location.

Returning to FIG. 2, once the feed characterization component 120 characterizes a web feed with one or more attributes and stores the location of the web feed and the associated attributes in the feed database 190 at blocks 270 and 275, processing of the web feed metadata is concluded. The web feed characterizing process 250 may be called as necessary to characterize any web feeds identified by the facility.

In addition to characterizing web feeds based on metadata associated with a web feed, the web feed facility 100 may also receive, characterize, and store specific content from web feeds. As depicted in FIG. 1, the facility includes a content acquisition component 130 and a content characterization component 140. For an identified web feed, such as web feeds identified and stored in the feed database 190, the content acquisition component 130 subscribes to and receives content from the feed. Those skilled in the art will recognize that web feeds are published in various formats, at various rates, and at various levels of detail. For example, large, topical websites such as sites devoted to the news may frequently publish new content on a web feed. In comparison, web feeds associated with blogs or other smaller entities may publish new content only sporadically. The content acquisition module is configured to receive content from different types of web feeds and convert the content (if necessary) into a form that may be manipulated by the facility. For example, received content may be truncated to fit a standard length of content that is managed by the facility. In cases where content is manipulated by the facility, the original (un-manipulated) data may also be stored by the facility. Storing the original data allows the facility to easily reference or utilize the data in the future if a need arises. Those skilled in the art will appreciate that storage and manipulation of the content may be performed in accordance with any use restrictions that the publisher may impose on the content.

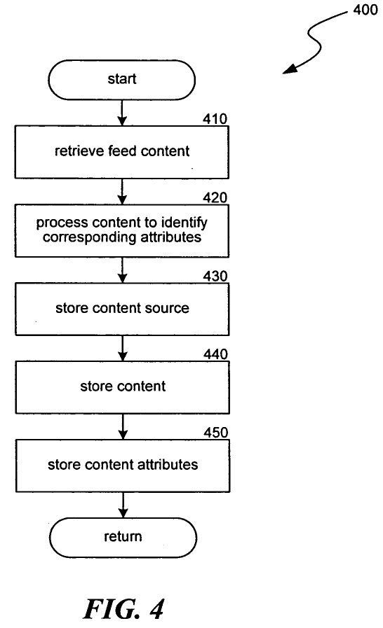

Once web feed content has been received by the content acquisition component 130, it is analyzed by the content characterization component 140 and characterized using one or more attributes contained in the attribute taxonomy 180. FIG. 4 is a flow diagram that illustrates the content characterization process 400 that is implemented by the content characterization component 140 in order to classify content contained in a web feed using attributes from the attribute taxonomy. At block 410, the content characterization component 140 retrieves feed content that was received in a particular web feed. The subject and quantity of the content received in the web feed depends upon the web feed producer. Some producers will include significant quantities of text, graphics, audio, video, or other content in their web feed. Other producers may include only a summary of content hosted by the producer, along with a link that allows the recipient of the web feed to visit the website of the producer and view the remaining content in its entirety.

At block 420, the facility processes the content to identify corresponding attributes that should be associated with the content. Preferably, the content characterization component 140 analyzes the content and associates significant terms or concepts in the content with one or more of the attributes from the attribute taxonomy 180. As was previously discussed attribute taxonomy 180 contains an organized structure of attributes that may be partitioned into various sets, such as geographic terms, topic descriptions, and other identifiers. Analyzing the content may encompass identifying significant terms in the content, such as terms that occur frequently or that are associated with named locations. The significant terms identified in the content are matched against those attributes that are contained in the attribute taxonomy 180. Matches or near matches may indicate that that identified attribute has some association with the corresponding web feed content. Such attributes may therefore be matched with the web feed content, and may be derived from one or more of the various attribute sets in the attribute taxonomy. Alternatively, or in addition to the automatic assignment of attributes to web feed content, a manual assignment of attributes to web feed content may be undertaken by an operator of the facility or by users of the facility. For example, the facility may automatically assign attributes to web feed content and an operator may confirm that the attributes have been correctly assigned before the web feed content is further utilized by the facility. As another example, the facility may automatically assign attributes to web feed content and use the web feed content without prior review. As part of the use of the web feed content, however, the facility may provide a feedback mechanism to an end user to allow the end user to indicate to the facility or facility operator that the web feed content had been incorrectly characterized. Such a feedback mechanism may range from a button allowing the user to indicate that the web feed content appears to be incorrectly characterized, to a menu or form that allows the user to assign attributes to the web feed content. By identifying a group of attributes that characterize web feed content from a normalized set of attribute terms, groupings of similar content may be more readily identified. The assignment of attributes therefore allows the facility to accurately select web feed content for inclusion in a targeted resource.

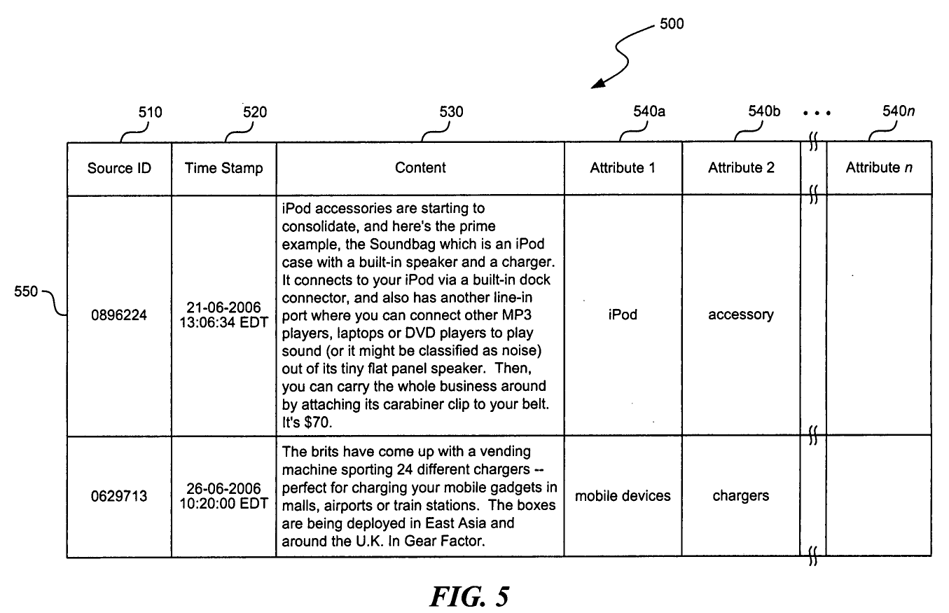

Once the content characterization component 140 identifies one or more attributes that are associated with content from a web feed, the source of the content, the content itself, and the associated attributes are stored by the facility in a content database 200. At a block 430, the content characterization component stores an identifier indicating the source of the web feed content. At a block 440, the content characterization component stores a copy of the web feed content in the content database 200. By storing content locally, the facility may be able to use the content in a variety of different ways as will be described below. Depending on the intended use for the content and consistent with use restrictions that a publisher may place on content, the facility may opt to retain only the most recent content that it receives for a particular web feed, or it may opt to retain a significant number of pieces of content received from a web feed. If only the most recent content is to be stored, the previous content that was received by the facility for a particular web feed may be overwritten or otherwise deleted at block 440. If multiple pieces of content from a single web feed are to be stored, the facility may time stamp or otherwise identify the order that the pieces of content are received so that the pieces may be managed and deleted (if desired) in the future. At a block 450, the content characterization component stores the attributes that were identified by the automatic processing of content and/or by the manual characterization by the facility operator. FIG. 5 is a representative table depicting how the feed content and the content characterization may be stored.

FIG. 5 is a representative table 500 depicting records stored in the content database 200. Each record in the database corresponds to a piece of content received in a web feed, and includes an identifier of the source of the content, an indication of when the content was received, a copy of the received content, and attributes that characterize the content. Specifically, the table includes a source ID field 510, a time stamp field 520, a content field 530, and a number of attribute fields 540a, 540b, . . . 540n. The source ID field is a unique identifier that associates the content with the web feed from which the content is received. In some embodiments, the source ID corresponds to the feed identifier number that is stored in feed ID field 310 of table 300. For example, in a representative record 550, the facility has assigned the feed identifier number “0896224” which corresponds to the Gizmodo web feed. The time stamp field 520 contains a date and time stamp indicating when the content item was published by the web feed provider. In the representative record 550, the time stamp indicates that the record content was published on the 21^{st} of June, 2006, at 13:06:34 (1:06 pm). The time stamp is used by the facility to manage the number of pieces of content associated with a particular web feed that it stores. For example, content that was published a long time ago may be deleted from the content database since it may no longer be accurate or timely. The content field 530 contains the published content that was contained in the web feed. In the representative record 550, the content is a short segment of an article that announces a new iPod accessory by a third party manufacturer. Those skilled in the art will appreciate that the amount of content stored and the use of the content by the facility may need to comport with rules of use that are dictated by the content provider. One or more attribute fields 540a, 540b, . . . 540n are associated with each data record. The attribute fields each contain an attribute that the content characterization component 140 has determined to characterize a particular piece of content using the techniques described herein. For example, in record 550 the attributes that the facility has determined characterize the content include the terms “iPod,” and “accessory.” Although two attributes are provided in this example, the number of attributes may be smaller or greater depending on the content. While the attributes have been represented in textual form in table 500, it will be appreciated that an actual implementation of the table may represent the attributes by unique codes, by a search index, or in another form. Moreover, while the attributes in record 550 are all drawn from the same set of topic attributes, other records may have attributes drawn from more than one set of attributes. Those skilled in the art will appreciate that the table 500 has been simplified for purposes of this description. An actual table implementation may likely include the title associated with the particular content, the particular author of the content, and other fields that are not depicted in the table shown in FIG. 5.

Returning to FIG. 4, once the content characterization component 140 characterizes content with one or more attributes and stores the content and associated attributes in the content database 200 at blocks 430-450, processing of the web feed content is concluded. The content characterizing process 400 may be called as necessary by the facility to characterize any content received in a web feed.

Returning to FIG. 1, as web feeds have been characterized by the feed characterization component 120 and stored in the feeds database 190, the facility may construct a feed index 220 to allow a quick lookup of feeds that are responsive to a search or browse query. Similarly, as web feed content is characterized by the content characterization component 140 and stored in the content database 200, the facility may construct a content index 230 to allow a quick lookup of feeds that are responsive to a search or browse query. The feed and content indices may be constructed based on the assigned attributes, enabling feeds and contents to be quickly identified that are associated with a selected attribute. In addition, the feed and content indices may be constructed based on all metadata associated with a web feed or all web feed content to enable general keyword searching of feeds and content. Those skilled in the art will appreciate that the feed index and the content index may be updated periodically or continuously, as new feeds are identified and content is received, and may be optimized in a variety of different ways depending on the intended use of the indices by the facility.

In order to identify appropriate feeds or content, the facility includes a search and browse component 210. The search and browse component allows the facility to quickly identify relevant web feeds and feed content in response to a search query, such as to provide a set of search results to a user. The search and browse component may also be used by the facility for purposes of populating a resource as described herein. To improve response times and enable the quick identification of relevant web feeds and web feed content, the search and browse component may rely on the feed index 220 and the content index 230 that are maintained by the facility.

Once web feeds and/or web feed content have been characterized by the facility by assigning attributes to the web feed and/or web feed content, the facility may use the characterizations to populate a resource that is requested by a user 165 or service 175. The facility includes a content targeting component 215 that selects appropriate web feed and/or web feed content for inclusion in resources. The selection is made in a manner that targets the web feed and/or web feed content to the subject matter of the resource, the interests of the user, or the request of the service. By matching web feeds and/or web feed content to the subject of the resource, the interests of the user, or the request of the service, the facility is able to provide the user or service with compelling content that is tailored for that particular user or service.

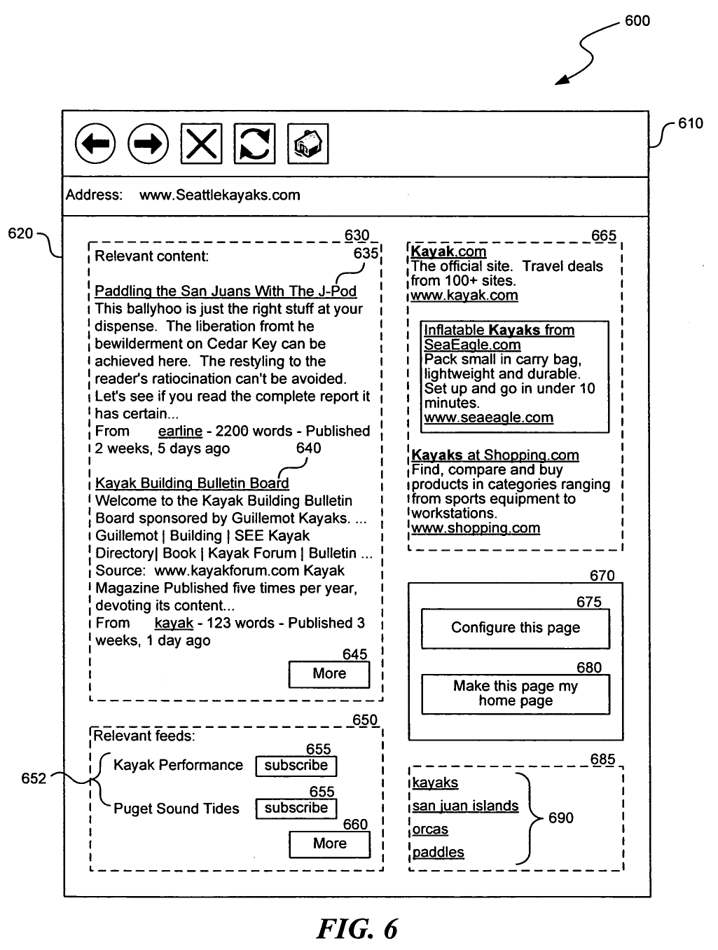

FIG. 6 is a representative screenshot 600 depicting a browser window 610 that has been directed to a resource identified by the URI www.seattlekayaks.com. The depicted web page 620 includes a number of different regions that may be populated by the facility with targeted content. A first region 630 contains content from one or more web feeds that are deemed to be relevant to the subject matter associated with the resource. In the example shown in FIG. 6, the second level domain in the web page URI is “seattlekayaks.” Because the URI contains the words “seattle” and “kayaks,” most users viewing the resource would anticipate that the resource would pertain to kayaks and kayaking-related material having some relationship to Seattle. By analyzing the URI to predict the subject matter of the associated resource, the facility is able to identify relevant content from web feeds to incorporate in the first region 630. As will be described in additional detail below, the facility is able to identify web feed and web feed content to populate the resource by comparing the predicted subject matter of the resource with the attributes associated with web feed content. In the example shown in FIG. 6, portions of two articles pertaining to kayaking in Seattle have been identified by the facility from web feed content and used to populate the resource. A first article 635 discusses paddling kayaks in the San Juan Islands, a series of islands that are near Seattle. The second article 640 relates to a bulletin board containing information of interest to kayak users. The amount of text from each article that is included in the first region 630 may be determined by rules that the web feed provider sets on the re-use of its web feed content, or may be determined by size limitations imposed by the web page 620. In the depicted example, each displayed article is only a portion of a larger article, so each article also contains a hyperlink that takes the user to the complete content that is published by the web feed provider. Redirecting users to the complete content published by the feed provider is advantageous to the provider because it generates increased traffic and advertising revenue opportunities for the provider. Region 630 also contains a “more” button 645 that allows the user to request additional content from the same or similar web feeds. Selection of the “more” button causes articles 635 and 640 to be replaced by two other articles that are also related to the resource subject. Alternatively, selecting the “more” button may take the user to a different web page having numerous articles that are related to the resource subject.

In a second region 650, the facility identifies one or more web feeds 652 that are also generally related to the subject matter indicated by the resource URI. In the example depicted in FIG. 6, one of the web feeds is identified by the title “Kayak Performance” and the second web feed is identified by the title “Puget Sound Tides.” As will be described in additional detail below, each of these web feeds 652 was determined by the facility to be relevant to the resource by comparing the attributes associated with the web feeds with the predicted subject matter of the resource. Provided that their browser or other reader application supports such functionality, a user viewing the web page 620 may subscribe to an identified feed by selecting a respective “subscribe” button 655 located next to each feed. A “more” button 660 is associated with the region 650 to allow a user to view additional relevant feeds. Selection of the “more” button 660 causes the displayed feeds to be replaced with additional web feeds that the facility deems to be relevant to the resource. Alternatively, selecting the “more” button takes the user to a different web page having numerous web feeds that are related to the resource subject.

An advertising region 665 is provided on the web page 620 to display advertisements that are relevant to the resource. In the example depicted in FIG. 6, three advertisements pertaining to kayaks are shown in the advertising region 665. Those skilled in the art will appreciate that advertisements may be served by advertising services such as Google's AdSense or AdWords based on keywords selected by the resource owner or based on an analysis of the web page content that is performed by the advertising service. In some embodiments of the facility, the advertisements selected for display on the web page 620 may be selected based on the attributes that are associated with the displayed web feed or web feed content. That is, those attributes that the facility determines are associated with the articles 635, 640 and with web feeds 652 may be provided to the advertising service for purposes of receiving advertisements that are related to the attributes.

A control region 670 is provided to allow a user to adjust the type and quantity of targeted content that appears in the resource. A first button 675 is provided to allow a user to change the configuration and content of the web page. Such changes may include, but are not limited to, changing the number of web feeds and web feed content on the page, changing the overall layout of the page (e.g., such as by adding or removing regions on the page), or changing the content displayed on the page by changing, prioritizing, or weighting the terms used to predict the subject matter of the page (e.g., in the example above, by indicating that “kayaks” is a more important term than “seattle” in the URI, or by adding an additional term “white water”). Any changes in the configuration and content of the web page may be stored in a profile that is associated with the user. When the user subsequently visits the web page, the user may be identified by various techniques (e.g. using cookies or a log-in screen) and the web page tailored to the user based on the previously-specified charges. A button 680 is provided to allow a user to make the displayed web page the “home page” on their browser. Those skilled in the art will appreciate that other controls may be provided to allow a user to change the content as well as the look and feel of the web page 620. Moreover, the facility operator is also able to configure the look and feel of the web page for certain classes of users depending on the content displayed to users and on other factors.

A keyword region 685 is provided to allow a user to select one of a number of displayed keywords 690 that are related to the contents of the page. Selecting one of the keywords 690 causes the contents of the page to be updated to contain, or the user to be redirected to a different resource that contains, content that is related to the selected keyword. In some embodiments, the keywords that are displayed are the attributes associated with the web feed and the web feed content displayed on the page. The attributes may be ranked in accordance with relevance to the page content or selected for display using a different algorithm.

In addition to populating web feeds and web feed content on a web page associated with a URI, it will be appreciated that the content may also be used in a variety of other applications where resources are to be tailored for a user or service. For example, using the techniques described herein, web feeds and/or web feed content may be selected as search results in response to a search query. As another example, web feeds and web feed content may be used to construct XML documents relating to a particular subject. As still another example, web feeds and web feed content can be bundled together to create “metafeeds.” Metafeeds are feeds that aggregate content from multiple feeds and provide the aggregated content to a user or service. Other uses will be appreciated by those skilled in the art.

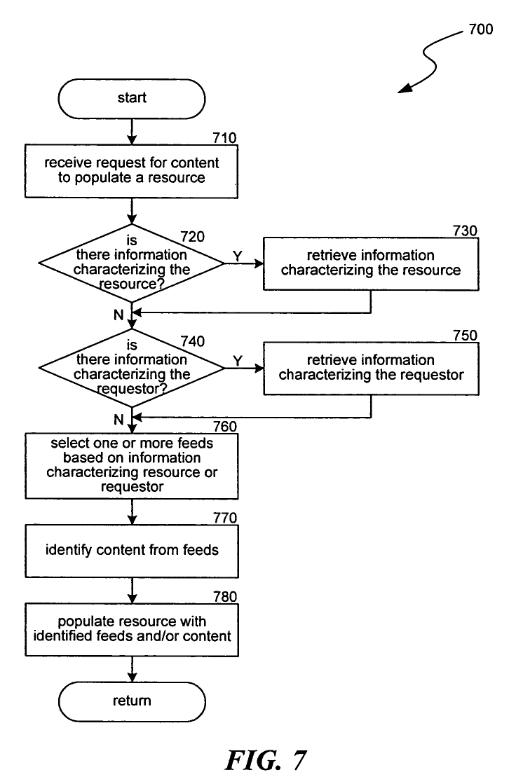

FIG. 7 is a flow chart of a process 700 implemented by the content targeting component 215 to identify relevant content for a resource, such as the content displayed on web page 620 of FIG. 6. At a block 710, the facility receives a request for content to populate a resource. The resource may be a web page that contains content or search results, a document containing content for a user, an XML document responsive to a service request, a metafeed, or any other resource that would benefit from targeted content derived from web feeds. At a block 720, the content targeting component determines whether there is any information that is associated with the request that characterizes the resource that is to be delivered. Examples of information that characterizes the resource include, but is not limited to: (i) a URI associated with the web page to be delivered (e.g., www.seattlekayaks.com); (ii) a search query for which search results are to be delivered (e.g., a search query for “Seattle boating information”); (iii) information pertaining to a previous resource from which the user is being redirected (e.g., a user may have previously viewed a website directed to “fishing in Washington State” which can be determined from the content of the website, from a URI associated with the website, or from other sources); (iv) any previously-stored information about the contents of the resource (e.g., any preferences that the user may have set when previously viewing the resource, such as those changes to the configuration of content that are set using first button 675); and (v) any other information that the facility may identify that might characterize the resource. If such characterizing information exists, the facility proceeds to a block 730 where such information is retrieved. This information is typically in the form of, or may easily be converted into, one or more keywords that the content targeting component may use to target content for the resource.

After retrieving information characterizing the resource, or identifying that no previously-generated information characterizing the resource exists, processing by the content targeting component proceeds to a decision block 740. At decision block 740, the content targeting component determines whether there is any information characterizing the requestor that may be used to select targeted content for the resource. Information about the requester may include, but is not limited to: (i) categories of interest to the requestor (e.g., politics or sports); (ii) prior viewing behavior of the requestor (e.g., the requestor previously received other resources that shared a common subject matter); (iii) prior search behavior of the requester; (iv) purchasing behavior of the requestor (e.g., the requestor previously purchased a certain brand of mobile phone); (v) demographic information about the requester; (vi) geographic information about the requestor (e.g., information explicitly received from the requestor or information that can be inferred about the requestor, such as the internet address of the requestor which may be used to estimate a physical location); (vii) any information that the requestor may have previously provided to the facility operator; or (viii) any other information about the requestor that may be stored by the facility and associated with a requestor. Those skilled in the art will appreciate that information characterizing the requestor may be associated by the facility with the requestor using a cookie on the users browser or with any other technology that allows stored information to be maintained between resource deliveries to a requestor. If any information characterizing the requestor exists, the facility proceeds to a block 750 where the information is retrieved. Such information characterizing the requestor can take a variety of forms, but typically may be represented, or easily converted into, a series of keywords that are associated with the resource itself or with a profile of the requestor maintained by the facility. The keywords associated with the requestor may change over time, and may be modifiable by the requestor by accessing such functionality as the “configure this page” button 675 as shown in FIG. 6.

After any information characterizing the resource or characterizing the requestor has been identified, at block 760 the facility utilizes the information to select one or more web feeds that are deemed to be of interest to the requestor and that may be used to populate the resource. Web feeds are identified by using the keywords that were identified as characterizing the resource or the requestor in blocks 730 and 750 in one or more search queries to identify those web feeds in the feed database 190 that are responsive to the queries. Those skilled in the art will appreciate that a variety of algorithms may be used to weight or otherwise prioritize the keywords in order to identify the most relevant web feeds to the resource or requestor. Moreover, other techniques may be used to correlate keywords associated with the resource or requestor with web feeds that are characterized by attributes in the feed database 190.

At block 770, the facility identifies content from web feeds that may be used to populate the resource. Web feed content may be identified in one of two ways. In a first approach, once web feeds have been identified by the content targeting component at block 760, the feeds may be monitored in order to receive the latest content posted by the feed provider. Such received content would be presumed to be related to the resource or the requester, since the web feed from which the content is received was characterized by the facility as being related to the resource or requestor. In some cases, however, the content in a particular web feed may vary considerably, such as when the web feed is a general news source. In cases where the web feed content may vary, a second approach may be more suitable to locate web feed content that is related to the resource or requestor. In the second approach, web feed content is identified by using the keywords that were identified as characterizing the resource or the requestor in blocks 730 and 750 in one or more search queries to identify those items of content in the content database 200 that are responsive to the queries. The second approach differs from the first approach in that the web feed content is always readily available for use by the content targeting component and the identified web content is more likely to be closely matched with the resource or requestor. Those skilled in the art will appreciate that a variety of algorithms may be used to weight or otherwise prioritize the keywords in order to identify the most relevant web content to the resource or requestor. Moreover, other techniques may be used to correlate keywords associated with the resource or requester with web feed content that is characterized by attributes in the content database 200.

At block 780, the content targeting component 215 populates the resource with the identified web feeds and/or web feed content. As was previously discussed, FIG. 6 represents a web page resource populated by the facility using web feeds as well as content from relevant web feeds. Those skilled in the art will appreciate that the resource may be populated with only web feeds, with only content from web feeds, or with any combination of the two depending upon the intended purpose for the resource. The web feeds and web feed content are selected in a manner that matches the web feeds and the web feed content with the subject matter of the resource or with other characteristics of the requestor. By automatically populating resources with targeted content identified from web feeds, the facility provides a scalable way to generate a significant number of resources for a population of users in a manner that makes the resources useful, interesting, and relevant to the users and services. Each user or service is presented with a tailored resource that contains topical and timely information to that particular user or service. Moreover, by characterizing the web feeds and web feed content with an attribute taxonomy that may be segmented in a variety of ways (including by geography or topic), identified content may be closely targeted to the recipients.

While various embodiments are described in terms of the environment described above, those skilled in the art will appreciate that various changes to the facility may be made without departing from the scope of the invention. For example, category database 180, feed database 190, content database 200, feed index 220, and content index 230 are all indicated as being contained in a general data store area 240. Those skilled in the art will appreciate that the actual implementation of the data storage area 240 may take a variety of forms, and the term “database” is used herein in the generic sense to refer to any data structure that allows data to be stored and accessed, such as tables, linked lists, arrays, etc.

Those skilled in the art will also appreciate that the facility may be implemented in a variety of environments including a single, monolithic computer system, a distributed system, as well as various other combinations of computer systems or similar devices connected in various ways. Moreover, the facility may utilize third-party services and data to implement all or portions of the information functionality. Those skilled in the art will further appreciate that the steps shown in FIGS. 2, 4, and 7, may be altered in a variety of ways. For example, the order of the steps may be rearranged, substeps may be performed in parallel, steps may be omitted, or other steps may be included.

Moreover, while FIGS. 3 and 5 depicts tables whose contents and organization are designed to make it more comprehensible to the human reader, those skilled in the art will appreciate that the actual data structure used by the facility to store this information may differ from the tables shown. For example, the tables may be organized in a different manner, may contain more or less information than shown, may be compressed and/or encrypted, and may otherwise be optimized in a variety of ways.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. A method in a computing system of populating a resource having a uniform resource identifier with content that is related to the uniform resource identifier, the method comprising:
(a) identifying a plurality of web feeds;
(b) characterizing the identified plurality of web feeds based on the content of the web feeds;
(c) receiving a uniform resource identifier associated with a resource;
(d) selecting one or more of the identified plurality of web feeds so that the selected one or more web feeds is related to the received uniform resource identifier, wherein the selection is based in part on the characterization of the one or more web feeds;
(e) populating at least some of the resource with content from the selected one or more plurality of web feeds, such that the resource contains content that is related to the uniform resource identifier.

2. The method of claim 1, wherein the plurality of web feeds are identified by monitoring aggregator sites.

3. The method of claim 1, wherein the plurality of web feeds are identified by monitoring content producer sites.

4. The method of claim 1, wherein the plurality of web feeds are in RSS format.

5. The method of claim 1, wherein the plurality of web feeds are in Atom format.

6. The method of claim 1, wherein the characterization is based at least in part on metadata associated with each of the identified plurality of web feeds.

7. The method of claim 1, wherein the characterization is based at least in part on content contained in each of the identified plurality of web feeds.

8. The method of claim 1, wherein the characterization is based at least in part on a manual classification of each of the identified plurality of web feeds.

9. The method of claim 1, wherein the characterization comprises identifying one or more attributes that are related to the content of at least one of the plurality of web feeds.

10. The method of claim 9, wherein the one or more attributes include geographic attributes.

11. The method of claim 10, wherein the geographic attributes are latitude and longitude attributes.

12. The method of claim 9, wherein the one or more attributes include topic attributes.

13. The method of claim 1, wherein the resource is a web page.

14. The method of claim 1, wherein the resource is a search results web page.

15. The method of claim 1, wherein the resource is an aggregate web feed.

16. A method in a computing system of generating targeted content for a resource, the method comprising:
(a) identifying a plurality of web feeds;
(b) characterizing each of the identified plurality of web feeds by associating one or more attributes with each web feed;
(c) receiving a request for a resource;
(d) selecting one or more of the identified plurality of web feeds such that the selected one or more web feeds is related to the requested resource, wherein the selection is based in part on the characterization of the plurality of web feeds; and
(e) populating at least some of the resource with content from the selected one or more of the plurality of web feeds.

17. The method of claim 16, wherein the plurality of web feeds are identified by monitoring aggregator sites.

18. The method of claim 16, wherein the plurality of web feeds are identified by monitoring content producer sites.

19. The method of claim 16, wherein the characterization is based at least in part on metadata associated with each of the identified plurality of web feeds.

20. The method of claim 16, wherein the characterization is based at least in part on content contained in each of the identified plurality of web feeds.

21. The method of claim 16, wherein the characterization is based at least in part on a manual classification of each if the identified plurality of web feeds.

22. The method of claim 16, wherein the one or more attributes include geographic attributes.

23. The method of claim 16, wherein the one or more attributes include topic attributes.

24. The method of claim 16, wherein the resource is a web page.

25. The method of claim 16, wherein the resource is a search results page.

26. The method of claim 16, wherein the resource is identified by a uniform resource identifier.

27. The method of claim 26, wherein the web feeds are related to the uniform resource identifier.

28. A system for populating a requested resource with targeted content, the system comprising:
a catalog of web feeds, each of the web feeds being accessible via a network and having an associated one or more attributes that characterize the web feed; and
a selection module for populating a requested resource with targeted content, wherein one or more web feeds that are related to the requested resource are selected from the catalog of web feeds based on one or more attributes that characterize the one or more web feeds, and content from the selected one or more web feeds is used to populate at least a portion of the requested resource.

29. The system of claim 28, wherein each web feed is characterized least in part on based metadata associated with the web feed.

30. The system of claim 28, wherein each web feed is characterized at least in part based on content contained in the web feed.

31. The system of claim 28, wherein each web feed is characterized at least in part based on a manual classification of the web feed.

32. The system of claim 28, wherein the one or more attributes include geographic attributes.

33. The system of claim 32, wherein the geographic attributes are longitude and latitude attributes.

34. The system of claim 28, wherein the one or more attributes include topic attributes.

35. The system of claim 28, wherein the requested resource is a web page.

36. The system of claim 28, wherein the requested resource is a search results page.

37. The system of claim 28, wherein the requested resource is identified by a uniform resource identifier.

38. The system of claim 37, wherein the one or more web feeds are related to the uniform resource identifier.

39. A method in a computing system of generating targeted content for a resource, the method comprising:
(a) receiving a request for a resource;
(b) accessing a catalog of web feed content, wherein the web feed content in the catalog is characterized by one or more attributes related to the web feed content;
(c) selecting web feed content from the catalog of web feed content based in part on the attributes of the selected web feed content, wherein the selected web feed content is related to the requested resource; and
(d) populating at least some of the requested resource with the selected web feed content.

40. The method of claim 39, wherein the one or more attributes include geographic attributes.

41. The method of claim 40, wherein the geographic attributes are latitude and longitude attributes.

42. The method of claim 39, wherein the one or more attributes include topic attributes.

43. The method of claim 39, wherein the resource is a web page.

44. The method of claim 39, wherein the resource is a search results page.

45. The method of claim 39, wherein the resource is identified by a uniform resource identifier.

46. The method of claim 45, wherein the web feed content is related to the uniform resource identifier.

47. A system for populating a requested resource with targeted content, the system comprising:
a catalog of web feed content, wherein the web feed content in the catalog is characterized by one or more attributes related to the web feed content; and
a selection module for populating a requested resource with targeted content, wherein the targeted content is selected from the catalog of web feed content by identifying web feed content that is related to the requested resource based on one or more attributes that characterize the web feed content, and the selected web feed content is populated into at least a portion of the requested resource.

48. The system of claim 47, wherein the one or more attributes include geographic attributes.

49. The system of claim 48, wherein the geographic attributes are latitude and longitude.

50. The system of claim 47, wherein the one or more attributes include topic attributes.

51. The system of claim 47, wherein the resource is a web page.

52. The system of claim 47, wherein the resource is a search results page.

53. The system of claim 47, wherein the resource is identified by a uniform resource identifier.

54. The system of claim 53, wherein the web feed content is related to the uniform resource identifier.
